(19) United States
(12) Patent Application Publication
(10) Pub. No.: US 2014/0269623 A1
(43) Pub. Date: Sep. 18, 2014

(54) METHOD AND APPARATUS FOR PDCCH POWER AND RATE CONTROL FOR DENSE SMALL CELLS

(71) Applicant: QUALCOMM INCORPORATED, San Diego, CA (US)

(72) Inventors: Ahmed Kamel SADEK, San Diego, CA (US); Chirag Sureshbhai PATEL, San Diego, CA (US)

(73) Assignee: QUALCOMM INCORPORATED, San Diego, CA (US)

(21) Appl. No.: 13/840,527

(22) Filed: Mar. 15, 2013

(51) Int. Cl. H04W 36/30; H04W 24/02

(52) U.S. Cl. CPC H04W 36/30; H04W 24/02
USPC 370/332; 370/331; 370/329

(57) ABSTRACT

System, apparatus, and methods are provided for improving channel quality and handover performance in a wireless communication network. A network entity may determine a resource element quantity for use by a control channel and may determine a power level for a resource element for use by the control channel. The network entity may assign the determined resource element quantity to the control channel and may implement the determined power level for the resource element. The network entity may determine a channel quality of the control channel and may determine a presence of an access terminal in a handover region. The determined resource element quantity may be based on the channel quality. The determined power level may be based on the channel quality.

### BACKGROUND

I. Field

The present disclosure relates to communication systems and to techniques for reducing interference and improving handover performance in a wireless communication network.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of mobile entities, such as, for example, user equipments (UEs). A UE may communicate with a base station via the downlink (DL) and uplink (UL). The DL (or forward link) refers to the communication link from the base station to the UE, and the UL (or reverse link) refers to the communication link from the UE to the base station.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs.

In recent years, users have started to replace fixed line broadband communications with mobile broadband communications and have increasingly demanded great voice quality, reliable service, and low prices, especially at their home or office locations. In order to provide indoor services, network operators may deploy different solutions. For networks with moderate traffic, operators may rely on macro cellular base stations to transmit the signal into buildings. However, in areas where building penetration loss is high, it may be difficult to maintain acceptable signal quality, and thus other solutions are desired. New solutions are frequently desired to make the best of the limited radio resources such as space and spectrum. Some of these solutions include intelligent repeaters, remote radio heads, and small-coverage base stations (e.g., picocells and femtocells).

The Femto Forum, a non-profit membership organization focused on standardization and promotion of femtocell solutions, defines femto access points (FAPs), also referred to as femtocell units, to be low-powered wireless access points that operate in licensed spectrum and are controlled by the network operator, can be connected with existing handsets, and use a residential digital subscriber line (DSL) or cable connection for backhaul. In various standards or contexts, a FAP may be referred to as a home node B (HNB), home e-node B (HeNB), access point base station, etc. A femtocell may be referred to as a small cell herein.

The physical downlink control channel (PDCCH) typically occupies the first OFDM symbol, the first and second OFDM symbols, or the first, second, and third OFDM symbols of a time slot. In areas with a high density of small cells, the majority of the small cells may have a light cell load or may even be unloaded. The small cells, including lightly loaded and unloaded small cells transmit pilot signals and PDCCH signals which cause interference to the PDCCH of neighboring small cells. Lightly loaded and unloaded small cells are therefore interfering with the PDCCH of loaded small cells. The interference also degrades handover performance of UEs to and from small cells. There is a need to reduce interference and improve handover performance in areas with a high density of small cells.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more aspects of the embodiments described herein, there is provided a method for improving channel quality and handover performance in a wireless communication network. A network entity determines a resource element quantity for use by a control channel and determines a power level for a resource element for use by the control channel. The network entity assigns the determined resource element quantity to the control channel and implements the determined power level for the resource element.

### BRIEF DESCRIPTION OF THE DRAWINGS

FIG. 1 is a block diagram conceptually illustrating an example of a telecommunications system;

FIG. 2 is a block diagram conceptually illustrating an example of a down link frame structure in a telecommunications system;

FIG. 3 is a block diagram conceptually illustrating a design of a base station/eNB and a UE;

FIG. 4 is a block diagram illustrating another example communication system;

FIG. 5 illustrates aspects of an example system of dense small cells;

FIG. 6 illustrates aspects of an example technique for reducing interference and improving handover performance;

FIG. 7 illustrates aspects of an example handover between small cells;

FIG. 8 shows an example methodology for protecting against malicious infrastructure in a wireless communication network; and

FIG. 9 is a block diagram of an example system for protecting against malicious infrastructure in a wireless communication network.

### DETAILED DESCRIPTION

Techniques for interference management in a wireless communication system are described herein. The techniques may be used for various wireless communication networks such as wireless wide area networks (WWANs) and wireless local area networks (WLANs). The terms “network” and “system” are often used interchangeably. The WWANs may be CDMA, TDMA, FDMA, OFDMA, SC-FDMA and/or other networks. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink (DL) and SC-FDMA on the uplink (UL). UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). A WLAN may implement a radio technology such as IEEE 802.11 (Wi-Fi), Hiperlan, etc.

The techniques described herein may be used for the wireless networks and radio technologies mentioned above as well as other wireless networks and radio technologies. For clarity, certain aspects of the techniques are explained in the exemplary context of 3GPP networks, and more particularly in the context of the interference management for such networks. The word “exemplary” is used herein to mean “serving as an example, instance, or illustration.” Any embodiment described herein as “exemplary” is not necessarily to be construed as preferred or advantageous over other embodiments.

FIG. 1 shows a wireless communication network 10, which may be an LTE network or some other wireless network (e.g., a 3G network or the like). Wireless network 10 may include a number of evolved Node Bs (eNBs) 30 and other network entities. An eNB may be an entity that communicates with mobile entities (e.g., user equipment (UE)) and may also be referred to as a base station, a Node B, an access point, etc. Although the eNB typically has more functionalities than a base station, the terms “eNB” and “base station” are used interchangeably herein. Each eNB 30 may provide communication coverage for a particular geographic area and may support communication for mobile entities (e.g., UEs) located within the coverage area. To improve network capacity, the overall coverage area of an eNB may be partitioned into multiple (e.g., three) smaller areas. Each smaller area may be served by a respective eNB subsystem. In 3GPP, the term “cell” can refer to the smallest coverage area of an eNB and/or an eNB subsystem serving this coverage area, depending on the context in which the term is used.

An eNB may provide communication coverage for a macro cell, a picocell, a femtocell, and/or other types of cell. A macro cell may cover a relatively large geographic area (e.g., several kilometers in radius) and may allow unrestricted access by UEs with service subscription. A picocell may cover a relatively small geographic area and may allow unrestricted access by UEs with service subscription. A femtocell may cover a relatively small geographic area (e.g., a home) and may allow restricted access by UEs having association with the femtocell (e.g., UEs in a Closed Subscriber Group (CSG), or closed access). In the example shown in FIG. 1, eNBs 30a, 30b, and 30c may be macro eNBs for macro cell groups 20a, 20b, and 20c, respectively. Each of the cell groups 20a, 20b, and 20c may include a plurality (e.g., three) of cells or sectors. An eNB 30d may be a pico eNB for a picocell 20d. An eNB 30e may be a femto eNB or femto access point (FAP) for a femtocell 20e.

Wireless network 10 may also include relays (not shown in FIG. 1). A relay may be an entity that can receive a transmission of data from an upstream station (e.g., an eNB or a UE) and send a transmission of the data to a downstream station (e.g., a UE or an eNB). A relay may also be a UE that can relay transmissions for other UEs.

A network controller 50 may couple to a set of eNBs and may provide coordination and control for these eNBs. Network controller 50 may include a single network entity or a collection of network entities. Network controller 50 may communicate with the eNBs via a backhaul. The eNBs may also communicate with one another, e.g., directly or indirectly via a wireless or wireline backhaul.

UEs 40 may be dispersed throughout wireless network 10, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc. A UE may be able to communicate with eNBs, relays, etc. A UE may also be able to communicate peer-to-peer (P2P) with other UEs.

Wireless network 10 may support operation on a single carrier or multiple carriers for each of the DL and UL. A carrier may refer to a range of frequencies used for communication and may be associated with certain characteristics. Operation on multiple carriers may also be referred to as multi-carrier operation or carrier aggregation. A UE may operate on one or more carriers for the DL (or DL carriers) and one or more carriers for the UL (or UL carriers) for communication with an eNB. The eNB may send data and control information on one or more DL carriers to the UE. The UE may send data and control information on one or more UL carriers to the eNB. In one design, the DL carriers may be paired with the UL carriers. In this design, control information to support data transmission on a given DL carrier may be sent on that DL carrier and an associated UL carrier. Similarly, control information to support data transmission on a given UL carrier may be sent on that UL carrier and an associated DL carrier. In another design, cross-carrier control may be supported. In this design, control information to support data transmission on a given DL carrier may be sent on another DL carrier (e.g., a base carrier) instead of the given DL carrier.

Wireless network 10 may support carrier extension for a given carrier. For carrier extension, different system bandwidths may be supported for different UEs on a carrier. For example, the wireless network may support (i) a first system bandwidth on a DL carrier for first UEs (e.g., UEs supporting LTE Release 8 or 9 or some other release) and (ii) a second system bandwidth on the DL carrier for second UEs (e.g., UEs supporting a later LTE release). The second system bandwidth may completely or partially overlap the first system bandwidth. For example, the second system bandwidth may include the first system bandwidth and additional bandwidth at one or both ends of the first system bandwidth. The additional system bandwidth may be used to send data and possibly control information to the second UEs.

Wireless network 10 may support data transmission via single-input single-output (SISO), single-input multiple-output (SIMO), multiple-input single-output (MISO), and/or multiple-input multiple-output (MIMO). For MIMO, a transmitter (e.g., an eNB) may transmit data from multiple transmit antennas to multiple receive antennas at a receiver (e.g., a UE). MIMO may be used to improve reliability (e.g., by transmitting the same data from different antennas) and/or to improve throughput (e.g., by transmitting different data from different antennas).

Wireless network 10 may support single-user (SU) MIMO, multi-user (MU) MIMO, Coordinated Multi-Point (CoMP), etc. For SU-MIMO, a cell may transmit multiple data streams to a single UE on a given time-frequency resource with or without precoding. For MU-MIMO, a cell may transmit multiple data streams to multiple UEs (e.g., one data stream to each UE) on the same time-frequency resource with or without precoding. CoMP may include cooperative transmission and/or joint processing. For cooperative transmission, multiple cells may transmit one or more data streams to a single UE on a given time-frequency resource such that the data transmission is steered toward the intended UE and/or away from one or more interfered UEs. For joint processing, multiple cells may transmit multiple data streams to multiple UEs (e.g., one data stream to each UE) on the same time-frequency resource with or without precoding.

Wireless network 10 may support hybrid automatic retransmission (HARQ) in order to improve reliability of data transmission. For HARQ, a transmitter (e.g., an eNB) may send a transmission of a data packet (or transport block) and may send one or more additional transmissions, if needed, until the packet is decoded correctly by a receiver (e.g., a UE), or the maximum number of transmissions has been sent, or some other termination condition is encountered. The transmitter may thus send a variable number of transmissions of the packet.

Wireless network 10 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

Wireless network 10 may utilize frequency division duplex (FDD) or time division duplex (TDD). For FDD, the DL and UL may be allocated separate frequency channels, and DL transmissions and UL transmissions may be sent concurrently on the two frequency channels. For TDD, the DL and UL may share the same frequency channel, and DL and UL transmissions may be sent on the same frequency channel in different time periods.

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A UE may be within the coverage of multiple eNBs. One of these eNBs may be selected to serve the UE. The serving eNB may be selected based on various criteria such as received power, path loss, signal-to-noise ratio (SNR), etc.

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type such as an access point including a femtocell, a picocell, etc. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4 and 9, and/or other processes for the techniques described herein. The memories 342 and 382 may store data and program codes for the base station 110 and the UE 120, respectively. A scheduler 344 may schedule UEs for data transmission on the downlink and/or uplink.

In related aspects, the base station 110 may include a radio component 348 (e.g., a WiFi radio component/module or the like) that is co-located with the components 312-344, wherein the base station 110 may use the component 348 to communicate via a first radio technology (e.g., WiFi), and may use ones of the other co-located components to communicate via a second radio technology (e.g., 3G CDMA, 4G LTE, or the like, or combinations thereof). Similarly, the UE 120 may include a radio component 390 (e.g., a WiFi radio component/module or the like) that is co-located with the components 352-382, wherein the UE may use the component 390 to communicate via the first radio technology, and may use ones of the other co-located components to communicate via the second radio technology. In further related aspects, the base station 110 may also include a network interface 302 for connecting to one or more other base stations or core network entities via wired network(s).

FIG. 4 is an illustration of a planned or semi-planned wireless communication environment 400, in accordance with various aspects. Communication environment 400 includes multiple access point base stations, including FAPs 410, each of which are installed in corresponding small scale network environments. Examples of small scale network environments can include user residences, places of business, indoor/outdoor facilities 430, and so forth. The FAPs 410 can be configured to serve associated UEs 40 (e.g., included in a CSG associated with FAPs 410), or optionally alien or visitor UEs 40 (e.g., UEs that are not configured for the CSG of the FAP 410). Each FAP 410 is further coupled to a wide area network (WAN) (e.g., the Internet 440) and a mobile operator core network 450 via a DSL router, a cable modem, a broadband over power line connection, a satellite Internet connection, or the like.

To implement wireless services via FAPs 410, an owner of the FAPs 410 subscribes to mobile service offered through the mobile operator core network 450. Also, the UE 120 can be capable to operate in a macro cellular environment and/or in a residential small scale network environment, utilizing various techniques described herein. Thus, at least in some disclosed aspects, FAP 410 can be backward compatible with any suitable existing UE 120. Furthermore, in addition to the macro cell mobile network 455, UE 120 is served by a predetermined number of FAPs 410, specifically FAPs 410 that reside within a corresponding user residence(s), place(s) of business, or indoor/outdoor facilities 430, and cannot be in a soft handover state with the macro cell mobile network 455 of the mobile operator core network 450. It should be appreciated that although aspects described herein employ 3GPP terminology, it is to be understood that the aspects can also be applied to various technologies, including 3GPP technology (Release 99 [Rel99], Rel5, Rel6, Rel7), 3GPP2 technology (1xRTT, 1xEV-DO Rel0, RevA, RevB), and other known and related technologies.

As discussed above, an eNB may provide communication coverage for a macro cell, a picocell, a femtocell, and/or other types of cell. Capacity offload gains of a femtocell network are maximized when femtocells are deployed on a dedicated carrier, and thus, there is no interference from a macro network on the same channel as the deployed femtocells. However, because bandwidth is such a scarce resource, bandwidth needs to be allocated and managed with great care and efficiency. Accordingly, an operator may decide if and/or when to dedicate a carrier to femtocells to maximize the capacity of the network.

In accordance with one or more embodiments of the present disclosure, there are provided techniques for reducing interference and improving handover performance in a wireless communication system. FIG. 5 illustrates aspects of an example system 500 of dense small cells. A large number of small cells 510 such as femtocell access points may be densely located in an area. The areas of coverage for the small cells 510 may significantly overlap each other. In certain situations, a small cell 510a may be heavily loaded, serving a large number of UEs 520a-c, while other small cells 510b-i may be lightly loaded, by UEs 520d-e or even unloaded. Each of the small cells 510 may broadcast pilot signals (e.g. on OFDM symbols 0, 4, 7, 11 of each time slot) that interfere with other small cells 510. Physical Downlink Control Channel (PDCCH) generally functions to carry resource assignments for UEs, contained in a Downlink Control Information (DCI) message. The PDCCH typically occupies the first symbol, the first and second symbols, or the first through third symbols of a time slot. The pilot signals and PDCCH from neighboring small cells 510 may cause high interference with the PDCCH symbols. In typical situations, interference on the first symbol of the PDCCH is the highest.

In some example embodiments, the decision to increase the number of occupied PDCCH symbols may be based on a channel quality of the PDCCH. For example, the channel quality can be defined by interference levels in the channel or by error rates experienced by the channel. For example, when a small cell 510 schedules resources to a UE 520 and sends a PDCCH, it expects the UE 520 to respond with an acknowledgement character (ACK) or negative acknowledgement character (NACK) carried over a PUCCH. If the small cell 510 does not receive a PUCCH ACK/NACK, it is an indication that the UE did not receive the transmitted PDCCH correctly, and hence can adjust its PDCCH error rate estimation. Thus, the interference level on the PDCCH could be estimated from Channel Quality Indication (CQI) feedback in relation to a PDCCH error rate.

In related embodiments, the decision to increase the number of occupied PDCCH symbols may be based on cell load experienced by the small call 510a. In related aspects, the decision to change power levels of occupied PDCCH symbols may also be based on the channel quality of the PDCCH.

In an example embodiment, the number of occupied PDCCH symbols for each small cell 510 may be randomized In related aspects, the number of occupied PDCCH symbols for each small cell 510 may be changed every set period of time. This is done for the purpose of having the small cells use different numbers of occupied PDCCH symbols, which would reduce interference.

In an example embodiment, the determined resource element quantity may be based on a resource element quantity of a neighboring access point. For example, a “time-share” between the neighboring access points may be established where the small cells 510 take turns occupying one PDCCH symbol, two PDCCH symbols, or three PDCCH symbols.

FIG. 6 illustrates aspects of an example technique for reducing interference and improving handover performance. Small cells 510a-d each transmits a PDCCH that interferes with the PDCCH of the other neighboring cells 510. In an example embodiment, each of the small cells 510 have a PDCCH that occupies only the first symbol. The small cell 510a may decide to increase the number of occupied PDCCH symbols by occupying the first, second, and third symbols for its PDCCH. Alternatively, the small cell 510a may decide to occupy the first and second symbols for its PDCCH. Doing so reduces the impact of interference on the PDCCH. In a related embodiment, the small cell 510a may additionally decrease a power level of the first PDCCH symbol or increase a power level of the second and third PDCCH symbol. Doing so reduces the interference of the first PDCCH symbol.

FIG. 7 illustrates aspects of an example handover between small cells. A serving small cell 710 may have a coverage area 715 and may be serving a UE 730. A neighboring cell 720 may have a coverage area 725. The serving small cell 710 may detect that the UE 730 has moved into a handover region between the serving small cell 710 and the neighboring small cell 720. The UE 730 may experience poor handover performance from the serving small cell 710 to the neighboring small cell 720 due to interference on PDCCH. In an example aspect, the serving small cell 710 may decide to increase the number of occupied PDCCH symbols by occupying the first, second, and third symbols for its PDCCH while the UE 730 is in the handover region. Doing so reduces the impact of interference on the PDCCH and improves handover performance.

In a related embodiment, the serving small cell 710 may additionally increase power on at least one of the PDCCH symbols. Doing so enhances the signal to interference plus noise ratio (SINR) of the PDCCH symbol and improves handover performance.

In a related aspect, the serving cell 710 may request neighboring cells to reduce their transmit power at least one PDCCH symbol. A temporary reduction of a neighboring cell's 720 transmit power on at least one PDCCH symbol improves reliability of PDCCH decoding for UE 730 in the handover region 735.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

In accordance with one or more aspects of the embodiments described herein, with reference to FIG. 8, there is shown an example methodology 800 for reducing interference and improving handover performance in a wireless communication network. The method 800 may involve, at 810, determining a resource element quantity for use by a control channel.

The method 800 may involve, at 820, determining a power level for a resource element for use by the control channel.

The method 800 may involve, at 830, assigning the determined resource element quantity to the control channel.

The method 800 may involve, at 840, implementing the determined power level for the resource element.

In related aspects, the control channel may be a PDCCH. The resource element quantity may define a count of OFDM symbols per time slot. The determined resource element quantity may be further based on a cell load.

With continued reference to FIG. 8, there are also shown further operations or aspects that are optional and may be performed by the network entity or component(s) thereof. The method 800 may terminate after any of the shown blocks without necessarily having to include any subsequent downstream block(s) that may be illustrated. It is further noted that numbers of the blocks do not imply a particular order in which the blocks may be performed according to the method 800.

The method 800 may optionally involve, at 850, determining a channel quality of the control channel.

In related aspects, the channel quality may be based on a cell density. A high density of small cell increases the likelihood of interference from other small cells. A small cell can determine cell density in a neighborhood by detecting signals from neighbor cells and the signal strength (e.g., received signal strength indicator (RSSI) and received signal code power (RSCP)). If the number of detected cells is higher than a certain threshold and/or if the signal strength from neighboring cells is above a certain threshold, the small cell can infer that the PDCCH channel quality is likely to be poor. The small cell may accordingly adjust the number of PDCCH symbols used and power levels of the PDCCH symbols.

In related aspects, the channel quality may be based on an interference level. The channel quality may also be based on a PDCCH error rate. The interference level on the PDCCH could be estimated from Channel Quality Indication (CQI) feedback in relation to a PDCCH error rate.

In related aspects, the determined resource element quantity may be based on the channel quality. The determined power level may also be based on the channel quality.

In related aspects, the determined resource element quantity may increase if the channel quality falls below a quality threshold. The determined power level for the resource element may decrease if the channel quality particular to the resource element falls below a quality threshold.

The method 800 may optionally involve, at 860, determining a presence of an access terminal in a handover region. The determined resource element quantity may be based on the determined presence. The determined power level may also be based on the determined presence.

The method 800 may optionally involve, at 860, sending a request for a neighboring access point to reduce a control channel power level.

In related aspects, the determined resource element quantity may be randomized. The determined resource element quantity may be changed every set period of time. The determined resource element quantity may be based on a resource element quantity of a neighboring access point.

In accordance with one or more aspects of the embodiments described herein, FIG. 9 is a block diagram of an example system for reducing interference and improving handover performance in a wireless communication network. The exemplary apparatus 900 may be configured as a computing device or as a processor or similar device/component for use within. In one example, the apparatus 900 may include functional blocks that can represent functions implemented by a processor, software, or combination thereof (e.g., firmware). In another example, the apparatus 900 may be a system on a chip (SoC) or similar integrated circuit (IC).

In one embodiment, apparatus 900 may include an electrical component or module 910 for determining a resource element quantity for use by a control channel.

The apparatus 900 may include an electrical component 920 for determining a power level for a resource element for use by the control channel.

The apparatus 900 may include an electrical component 930 for assigning the determined resource element quantity to the control channel.

The apparatus 900 may include an electrical component 940 for implementing the determined power level for the resource element.

The apparatus 900 may optionally include an electrical component 950 for determining a channel quality of the control channel.

The apparatus 900 may optionally include an electrical component 960 for sending a request for a neighboring access point to reduce a control channel power level.

The apparatus 900 may optionally include an electrical component 960 for determining a presence of an access terminal in a handover region.

In further related aspects, the apparatus 900 may optionally include a processor component 902. The processor 902 may be in operative communication with the components 910-970 via a bus 901 or similar communication coupling. The processor 902 may effect initiation and scheduling of the processes or functions performed by electrical components 910-970.

In yet further related aspects, the apparatus 900 may include a radio transceiver component 903. A standalone receiver and/or standalone transmitter may be used in lieu of or in conjunction with the transceiver 903. The apparatus 900 may also include a network interface 905 for connecting to one or more other communication devices or the like. The apparatus 900 may optionally include a component for storing information, such as, for example, a memory device/component 904. The computer readable medium or the memory component 904 may be operatively coupled to the other components of the apparatus 900 via the bus 901 or the like. The memory component 904 may be adapted to store computer readable instructions and data for affecting the processes and behavior of the components 910-970, and subcomponents thereof, or the processor 902, or the methods disclosed herein. The memory component 904 may retain instructions for executing functions associated with the components 910-970. While shown as being external to the memory 904, it is to be understood that the components 910-970 can exist within the memory 904. It is further noted that the components in FIG. 9 may comprise processors, electronic devices, hardware devices, electronic sub-components, logical circuits, memories, software codes, firmware codes, etc., or any combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of reducing interference and improving handover performance in a wireless communication network, comprising:
determining a resource element quantity for use by a control channel;
determining a power level for a resource element for use by the control channel;
assigning the determined resource element quantity to the control channel; and
implementing the determined power level for the resource element.

2. The method of claim 1, wherein the control channel comprises a PDCCH.

3. The method of claim 1, wherein the resource element quantity defines a count of OFDM symbols per time slot.

4. The method of claim 1, wherein the determined resource element quantity is further based on a cell load.

5. The method of claim 1, further comprising determining a channel quality of the control channel.

6. The method of claim 5, wherein the channel quality is based on a cell density.

7. The method of claim 6, wherein the cell density is determined based on at least one of a received signal strength indicator (RSSI) and a received signal code power (RSCP).

8. The method of claim 5, wherein the channel quality is based on an interference level.

9. The method of claim 5, wherein the channel quality is based on a PDCCH error rate.

10. The method of claim 5, wherein the determined resource element quantity is based on the channel quality.

11. The method of claim 5, wherein the determined power level is based on the channel quality.

12. The method of claim 5, further comprising sending a request to a neighboring access point to reduce a control channel power level.

13. The method of claim 1, further comprising determining a presence of an access terminal in a handover region.

14. The method of claim 12, wherein the determined resource element quantity is based on the determined presence.

15. The method of claim 12, wherein the determined power level is based on the determined presence.

16. The method of claim 1, wherein the determined resource element quantity is randomized.

17. The method of claim 1, wherein the determined resource element quantity is changed every set period of time.

18. The method of claim 1, wherein the determined resource element quantity is based on a resource element quantity of a neighboring access point.

19. A wireless communication apparatus, comprising:
at least one processor configured to:
determine a resource element quantity for use by a control channel;
determine a power level for a resource element for use by the control channel;
assign the determined resource element quantity to the control channel; and
implement the determined power level for the resource element; and
a memory coupled to the at least one processor for storing data.

20. The apparatus of claim 19, wherein the at least one processor is further configured to determine a channel quality of the control channel.

21. The apparatus of claim 19, wherein the at least one processor is further configured to determine a presence of an access terminal in a handover region.

22. A wireless communication apparatus, comprising:
means for determining a resource element quantity for use by a control channel;
means for determining a power level for a resource element for use by the control channel;
means for assigning the determined resource element quantity to the control channel; and
means for implementing the determined power level for the resource element.

23. The apparatus of claim 22, further comprising means for determining a channel quality of the control channel.

24. The apparatus of claim 22, further comprising means for determining a channel quality of the control channel.

25. A computer program product, comprising:
non-transitory computer-readable medium comprising code for causing a computer to:
determine a resource element quantity for use by a control channel;
determine a power level for a resource element for use by the control channel;
assign the determined resource element quantity to the control channel; and
implement the determined power level for the resource element.

26. The computer program product of claim 25, where the computer-readable medium comprises code for further causing the at least one computer to determine a channel quality of the control channel.

27. The computer program product of claim 25, where the computer-readable medium comprises code for further causing the at least one computer to determine a presence of an access terminal in a handover region.
